(19) United States
(12) Patent Application Publication
(10) Pub. No.: US 2009/0030781 A1
(43) Pub. Date: Jan. 29, 2009

(54) Creating and Displaying Universal Ad Over Multiple Different Platforms

(76) Inventors: Satish Mehta, Fremont, CA (US); Srinivas Margsahayam, San Jose, CA (US)

Correspondence Address: STATTLER - SUH PC, 60 SOUTH MARKET STREET, SUITE 480, SAN JOSE, CA, 95113, US

(21) Appl. No.: 11/782,243

(22) Filed: Jul. 24, 2007

(51) Int. Cl. G06Q 30/00

(52) U.S. Cl. 705/14

(57) ABSTRACT

A method and system are provided for creating and displaying a universal ad over multiple different platforms. In one example, the method includes creating a universal ad by generating a superset ad, identifying different parts of the superset ad as separate components, matching the separate components to their respective media, attaching tags to each separate component, and converting the superset ad to a universal ad.

### FIELD OF THE INVENTION

The present invention relates to ad delivery over multiple different platforms. More particularly, the present invention relates to eliminating redundancies in an ad delivery process to thereby make the ad delivery process more efficient.

### BACKGROUND OF THE INVENTION

An advertiser, such as Ford® or McDonald's®, generally contracts an advertising agency for ads in different media for its products. Such media may include banner display ads, textual ads (which may appear as hyperlinks), streaming ads (which stream across a digital display like stock quotes), mobile phone ads, print media ads, for example, in newspapers, magazines and posters. It is quite possible that the advertiser may engage one or more advertising agencies that specialize in creating ads for one or more of the above media.

Unfortunately, the advertising agency in turn must generate ads specific to specific medium. For each medium, the ads are specifically generated. Such custom tailored generation implies that the person concerned with creating ads must generate a separate ad for each medium. The number of different ads is about equal to the number of different media. Further, once an advertising firm creates an ad, the ad is limited and very specific for its very specific media. For example, ads created for a browser on a desktop cannot be seen correctly over a mobile phone. Similarly, an ad created for, say, a daily newspaper cannot be printed in a glossy magazine. Often, the limitations are due to the fact that different media have different ways of exposing a product's ad.

Another problem arises when the advertiser wishes to add a new type of medium to the existing types of mediums. The ad agency must figure out a way to display the same product, for which there already are a number of ads, on the newly invented medium. The ad agency must create an entirely new ad for that same product in order to display the product's ad on that new medium. This problem is compounded when the ad agency services multiple companies in a similar manner.

### SUMMARY OF THE INVENTION

What is needed is an improved system having features for addressing the problems mentioned above and new features not yet discussed. Broadly speaking, the present invention fills these needs by providing a method and system of creating and displaying a universal ad over multiple platforms. It should be appreciated that the present invention can be implemented in numerous ways, including as a method, a process, an apparatus, a system or a device. Inventive embodiments of the present invention are summarized below.

In one embodiment, a method of creating a universal ad is provided. The method comprises generating a superset ad, identifying different parts of the superset ad as separate components, matching the separate components to their respective media, attaching tags to each separate component, and converting the superset ad to a universal ad.

In another embodiment, a method of displaying a universal ad is provided. The method comprises reading the universal ad replete with tags for different forms of media, identifying different tags attached to the universal ad, the tags being associated with components of the universal ad, matching each component with their respective media forms, attaching property values to each component, and displaying the universal ad correctly on a given media form.

In still another embodiment, a computer-readable medium carrying one or more instructions for creating a universal ad is provided. The one or more instructions, when executed by one or more processors, cause the one or more processors to perform the steps of generating a superset ad, identifying different parts of the superset ad as separate components, matching the separate components to their respective media, attaching tags to each separate component, and converting the superset ad to a universal ad.

The invention encompasses other embodiments configured as set forth above and with other features and alternatives.

### BRIEF DESCRIPTION OF THE DRAWINGS

The present invention will be readily understood by the following detailed description in conjunction with the accompanying drawings. To facilitate this description, like reference numerals designate like structural elements.

FIG. 1 is a block diagram of a universal ad creation, system including a universal ad creation interface, in accordance with an embodiment of the present invention;

FIG. 2 displays a browser page, in accordance with an embodiment of the present invention;

FIG. 3 is a block diagram of a universal ad display system including a universal ad display interface, in accordance with an embodiment of the present invention;

FIG. 4 is a flowchart of a method for creating a universal ad, in accordance with an embodiment of the present invention; and

FIG. 5 is a flowchart of a method for displaying a universal ad, in accordance with an embodiment of the present invention.

### DETAILED DESCRIPTION

An invention for creating and displaying a universal ad is disclosed. Numerous specific details are set forth in order to provide a thorough understanding of the present invention. It will be understood, however, to one skilled in the art, that the present invention may be practiced with other specific details.

It would be desirable for an advertiser or advertising agency contracted to do the following: generate one ad for a given product that is universally compatible with all designated platforms, in other words, make an intelligent ad such that the ad could change or mutate itself according to the reading qualities of the displaying media and still appear as if the ad were created specifically for each medium. Such PAA (platform aware ads) or intelligent ads could bring down the cost of advertising for an advertiser, the company displaying the ad and, of course, the end product manufacturer of the advertised product. These intelligent ads reduce the mean time to market for the advertising of a given product across all types of media. Note that the terms “media”, “media form” and “platform” may be used interchangeably in this description.

The present invention provides a method for an advertiser to create one universal ad for a given product for multiple platforms. The advertiser would be able to tag different components of that ad to ensure that it becomes usable over different media. The invention is directed toward two different systems—one for creating the universal ads and another for displaying those ads on different forms of media.

The first part of the universal ad system is called the ACI (ad creation interface). The second part of the universal ad system is called the ADI (ad display interface).

The ACI mainly comes into play alter an ad has been created. The ADI is called every time an ad is required to be displayed on any media. The ADI is a frequently used interface, as it will be called for use every time an ad is required to be displayed. Media, like a browser for example, that requires frequent displays of ads will require the ads to pass through the ADI every time the ads are displayed. To avoid degradation of performance, the media, like a browser, that involves a high frequency of displaying an ad will have the ability to cache the tags which make the ADI not trade universality of display for performance.

On a very high level, we can say that the ACI and ADI are tools that convert the otherwise static and almost non-intelligent ads into highly intelligent, universal ads. The method of the present invention reduces the development cost per ad for advertisers. For a given product or service, the advertiser will be required to develop only one ad and then attach tags to the ad which will make the ad usable by all media forms.

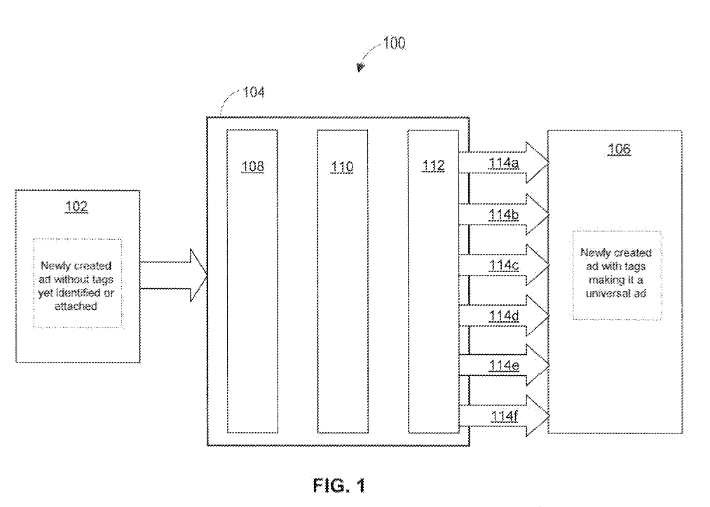

FIG. 1 is a block diagram of a universal ad creation system 100 including a universal ACI 104, in accordance with an embodiment of the present invention. The universal ad creation system 100 includes three blocks. The first block is a new ad creator 102, which creates new ads without any tags or components identified. The new ad creator 102 may be, for example, an ad agency. This new ad creator 102 just generated a newly created ad. Assume, at this point, that this newly created ad will be a superset ad or an “uber” ad. This means that the newly created ad has all parts suitable for the different media desired. For example, the newly created ad may have a .wav file to run over an audio media like radio, a .wmv file to run over a medium like TV or video player. The newly created ad may also contain formatted documents for media, such as browser media, or print media. The newly created ad is generated by different tools, which may include a media player, an html page generating tool, a document formatting tool such as Microsoft® Word or Adobe® Acrobat®. The newly created ad is then declared complete.

The newly created ad is then parsed via the universal ACI 104, the second block. The universal ACI 104 includes a components separator 108, which is a user interlace allowing the user to identify readily different parts of the newly created ad as separate components. Once the parts have been broken down to separate components in the components separator 108, each component will be matched to their respective media in the media matcher 110. For example, a component like a formatted document will be matched with all different media that could possibly display it. Such media may include, for example, a browser, television and print media. The universal ACT 104 will also identify all the attributes of a given component. Different components will have all or at least some of their attributes as different from the other components. For example, a component like a video clip will be entirely different from a .pdf document but will still have some similar attributes like an audio clip (both may have sound track).

The component tagger 112 of the universal ACI 104 applies tags to each component to create tagged components. This example shows tags 114a-114f. These tags could basically be either in the form of XML tags or some other dynamically read tags. These tags could designate the size (height/width), shape (rectangle/square/circle etc), font characteristics, display characteristics (hide or show the component), other properties and coordinates in terms of each attribute of each component.

Once these tags have been applied, ad converter 106 changes the ad from a raw superset ad to a universal ad. The term universal ad implies that the same ad is usable on different media with entirely different properties of displaying ads.

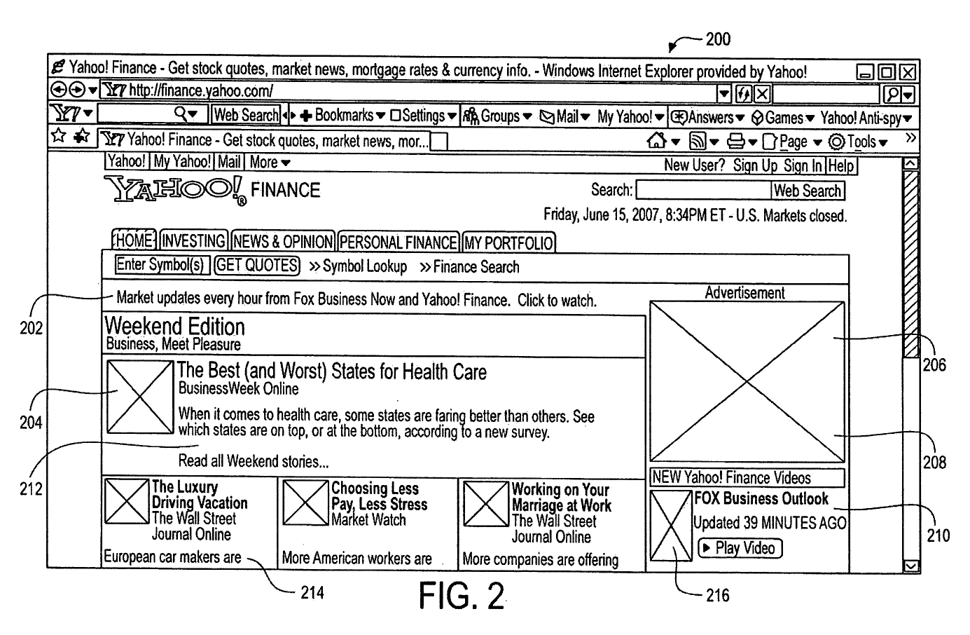

FIG. 2 displays a browser page 200 (in this ease, of http://finance.yahoo.com), in accordance with an embodiment of the present invention. The browser page 200 has different ads embedded in the same browser page. The different ads include a web ad hyperlink 202, print media static gif 204, video clip plus audio ad 206, an audio clip 208, a banner ad 210, static gif for print media 212, a text ad 214 and a streaming ad 216. This page presents us a good example of what happens to a single product, multiple media and therefore multiple ads. In another example, the same universal ad may be used to advertise the single product on a different platform, such as television, newspaper or magazine.

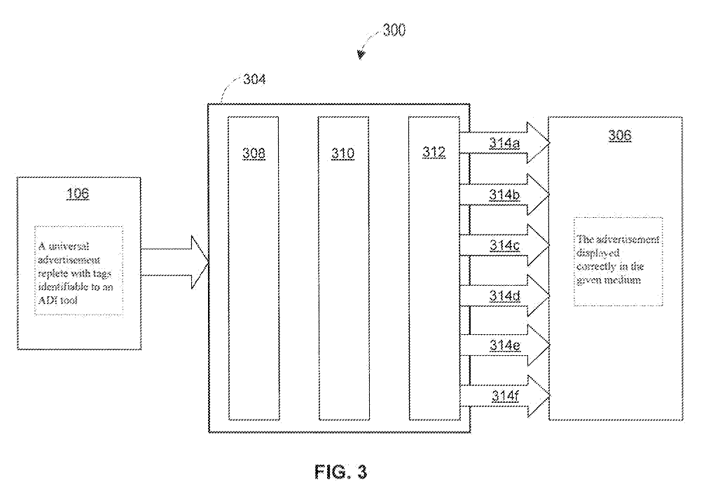

FIG. 3 is a block diagram of a universal ad display system 300 including a universal ADI 304, in accordance with an embodiment of the present invention. The ad display system 300 includes three blocks. The first block is a universal ad reader 302. Examples of a universal ad reader include, but are not limited to, an html browser, a media player or other reading device. The universal ad reader 302 has the capability to read, understand and translate a wide range of formatted content. Now, suppose a universal ad created via the universal. ACI 104 discussed with respect to FIG. 1 is subjected to the universal ad reader 302. The universal ad reader 302 recognizes the universal ad as being replete with all of its tags for different forms of media. The universal ad is then passed to the universal ADI 304, the second block.

The universal ADI 304 has three sub components. The tag identifier 308 identifies different tags attached to the components of the universal ad. The tag matcher 310 matches these components with their respective media form(s). The tag translator 312 translates the values of the attributes of those components written as tags, and attaches property values to those components. This example shows property values 314a-314f. After going through the tag translator 312, what's left is a subset of the universal ad that has property values that are tailored for the current reader(s). For example, the universal ACT 304 will not only be able to tell what font size and type for some written text inside the ad, but also will be able to tell what shaped box (circle/square/rectangle etc) to show that text in. Similarly, the universal ACI 304 will be able to instruct the other esoteric components of the ad, like audio/video clips—on a print media form of display—to simply hide them. The ad is appropriately displayed on the given ad display 306, which may be, for example, a browser, a television, a newspaper or magazine.

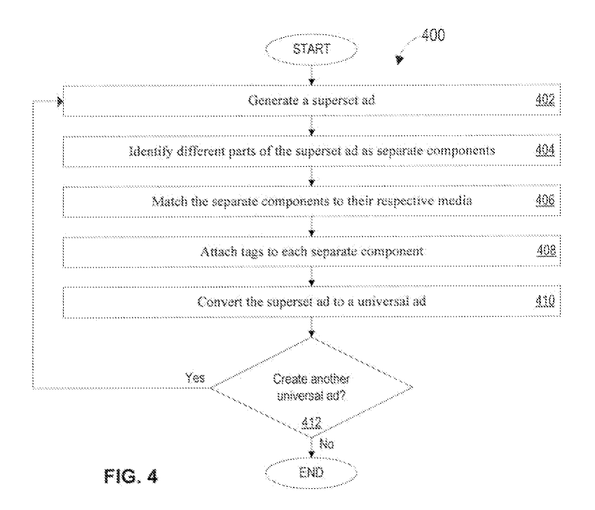

FIG. 4 is a flowchart of a method 400 for creating a universal ad, in accordance with an embodiment of the present invention. The steps of this method 400 may be carried out by the universal ad creation system discussed with reference to FIG. 1. The method 400 starts in step 402 where the universal ad creation system generates a superset ad. For example, a user, which may be an advertising agency, creates this superset or “uber” ad, as discussed above with reference to FIG. 1. The newly created ad has all parts suitable for different media desired, but so far is without any tags or components identified. Next, in step 404, the universal ad creation system, identifies different parts of the superset ad as separate components. A component separator is provided which includes a user interface allowing the user to identify readily different part of the newly created ad separate components. The user creates attributes. The user may create attributes that are custom tailored for the particular user. Examples of attributes include size, shape, hide, display, color, font, animate and scroll. Also, the user may new attributes providing the tool scalability for future forms of attributes that the user may attach to components of the ad.

Once the parts have been broken down into separate components, the method 400 moves to step 406 where the system matches the separate components to the respective media. In other words, the system identifies the PAA components in the ad, decides the attributes for the tags for each component and decides the values for each attribute. Next, in step 408, the universal ad creation system attaches the attributes in the form of tags to each component to create tagged components. Once these tags have been attached, the universal ad creation system changes the ad from a raw superset ad to a universal ad. The tags may be either embedded in the universal ad itself of may be attached as a separate file with the ad.

At this point, the user may use a UI/GUI (user interface or graphical user interface) to display their ad as the ad would look in different selected media. Doing so would allow the user a preview the universal ad in all the selected forms of media. In decision operation 412, the system decides whether another universal ad is to be created. If so, the method 400 returns to step 402, where the method 400 involves generating another superset ad and continues from there. If not, the method 400 is at an end.

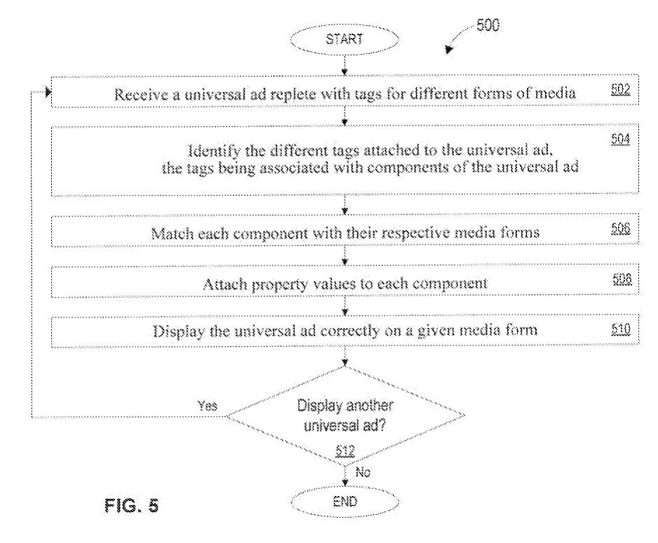

FIG. 5 is a flowchart of a method 500 for displaying a universal ad, in accordance with an embodiment of the present invention. The method 500 starts in step 502 where the universal ad display system reads a universal ad. This universal ad is the output of the method 500 of FIG. 4. The universal ad display system reads the ad and recognizes the universal ad as being replete with all of its tags for different forms of media, such as browser, television and print media. Next, in step 504, the universal ad display system identifies the different tags attached to the universal ad. These tags are associated with various components of the universal ad. The method 500 then moves to step 504 where the system matches each component with their respective media forms. The system translates the values of the attributes of those components written as tags. Then, in step 508, the system attaches property values to those components. What's left is a subset of the universal ad that has property values that are tailored for the currently selected reader(s). In step 510, the universal ad is then displayed correctly on a given platform. For example, the ad is uploaded onto the Internet, televised on television or printed on print media. Depending on the medium displaying the ad, a tag may affect the universal ad's displayed characteristics by displaying, hiding, resizing, re-coloring or generally changing of the behavior of the respective component in the ad. In decision operation 512, the system decides whether another universal ad is to be displayed. If so, the method 500 returns to step 502, where the method 500 involves generating another superset ad and continues from there. If not, the method 500 is at an end.

A superset ad, after it has been subjected to the universal ad creation system and converted into a universal ad, may be replete with tags that look something like what is given in Table 1 below.

TABLE 1
Example of Tags Embedded in a Universal Ad

```
Component 1 : Logo & Banner Ad
    <if banner > Show logo and Text header , hide audio
    < if search ad> show hyperlink , hide video hide audio hide
    banner hide logo
    <if mobile > show logo with audio
    <if video > Show logo and text header with audio
    < if audio > hide text and Logo , Play audio
    < if print media > show logo and Text Header , hide audio
    < if streaming > show Logo and Text Header , hide audio hide video
Component 2 : Video Clip and Audio Ad
      <if banner > hide
    < if search ad> hide
    <if mobile > show video and audio clip short version
    <if video > show video and audio clip full length version
    < if audio > play audio clip only
    < if print media > hide
    < if streaming > hide
Component 3: Login for web and mobile
      <if banner > show gif + hyperlink
    < if search ad> show text hyperlink
    <if mobile > show login page + logo
    <if video > hide
    < if audio > hide
< if print media > hide
    < if streaming > hide
```

The universal ad creation system creates tags and matches the tags to their respective media. The universal ad display system reads the values of those tags and translates the properties for each component. These attributes not only decide the media on which the specific components will appear, but also decide, for example, the size, shape and color of the components. The attributes for the components are decided by the tags.

### Computer Readable Medium Implementations

Portions of the present invention may be conveniently implemented using a conventional general purpose or a specialized digital computer or microprocessor programmed according to the teachings of the present disclosure, as will be apparent to those skilled in the computer art.

Appropriate software coding can readily be prepared by skilled programmers based on the teachings of the present disclosure, as will he apparent to those skilled in the software art. The invention may also be implemented by the preparation of application specific integrated circuits or by interconnecting an appropriate network of conventional component circuits, as will be readily apparent to those skilled in the art.

The present invention includes a computer program product which is a storage medium (media) having instructions stored thereon/in which can be used to control, or cause, a computer to perform any of the processes of the present invention. The storage medium can include, but is not limited to, any type of disk including floppy disks, mini disks (MD's), optical disks, DVD, CD-ROMS, micro-drive, and magneto-optical disks, ROMs, RAMs, EPROMs, EEPROMs, DRAMs, VRAMs, flash memory devices (including flash cards), magnetic or optical cards, nanosystems (including molecular memory ICs), RAID devices, remote data storage/archive/warehousing, or any type of media or device suitable for storing instructions and/or data.

Stored on any one of the computer readable medium (media), the present invention includes software for controlling both the hardware of the general purpose/specialized computer or microprocessor, and for enabling the computer or microprocessor to interact with a human user or other mechanism utilizing the results of the present invention. Such software may include, but is not limited to, device drivers, operating systems, and user applications. Ultimately, such computer readable media further includes software for performing the present invention, as described above.

Included in the programming (software) of the general/specialized computer or microprocessor are software modules for implementing the teachings of the present invention, including but not limited to generating a superset ad, identifying different parts of the superset ad as separate components, matching the separate components to their respective media, attaching tags to each separate component, converting the superset ad to a universal ad, reading the universal ad replete with tags for different forms of media, identifying different tags attached to the universal ad, matching components with their respective media forms, attaching property values to each component, and displaying the universal ad correctly on a given media form, according to processes of the present invention.

### Advantages

Advertising on the internet has different media, for example, banner ads, text ads, streaming ads such as stock quotes, ads on mobile, etc. Prior to this invention, advertisers had to make the ads separately suitable for each specific platform, for example, personal computer, mobile phone, television, print, etc. The present invention gives advertisers the capability of developing one single universal ad that works across all the media. Such a universal ad has tags to identify the medium on which the ad can be displayed. These tags are on one superset advertisement. Also, these tags are on each component of the ad and, depending on the media, the tags are intelligent to show, hide, and resize the specific component. These ads may be referred to as PAAs (platform aware ads) or highly intelligent ads.

In the foregoing specification, the invention has been described with reference to specific embodiments thereof. It will, however, be evident that various modifications and changes may be made thereto without departing from the broader spirit and scope of the invention. The specification and drawings are, accordingly, to be regarded in an illustrative rather than a restrictive sense.

1. A method of creating a universal ad, the method comprising:
generating a superset ad;
identifying different parts of the superset ad as separate components;
matching the separate components to their respective media;
attaching tags to each separate component; and
converting the superset ad to a universal ad.

2. The method of claim 1, wherein the superset ad includes all parts suitable for different selected media.

3. The method of claim 1, wherein generating the superset ad is carried out by at least one of:
a media player;
an html page generating tool; and
a document formatting tool.

4. The method of claim 1, wherein each different component will have at least some of its attributes as different from other components.

5. The method of claim 1, wherein the universal ad is usable on different platforms with entirely different properties of displaying ads.

6. A method of displaying a universal ad, the method comprising:
reading the universal ad replete with tags for different forms of media;
identifying different tags attached to the universal ad, the tags being associated with components of the universal ad;
matching each component with their respective media forms;
attaching property values to each component; and
displaying the universal ad correctly on a given media form.

7. The method of claim 6, wherein the reading the universal ad is carried out by a universal ad reader capable of reading, understanding and translating a wide range of formatted content.

8. The method of claim 6, wherein the step of reading comprises recognizing the universal ad is replete with the tags for different forms of media.

9. The method of claim 6, wherein the matching each component is followed by translating the values of the attributes of the components written as tags.

10. The method of claim 6, wherein the attaching property values comprises creating a subset of the universal ad.

11. The method of claim 10, wherein the subset of the universal ad has property values that are tailored for a currently selected reader.

12. An apparatus for creating a universal ad, the apparatus comprising:
an ad creator configured to generate a superset ad;
a components separator configured to identify different parts of the superset ad as separate components;
a media matcher configured to match the separate components to their respective media;
a component tagger configured to attach tags to each separate component; and
an ad converter configured to convert the superset ad to a universal ad.

13. The apparatus of claim 12, wherein the superset ad includes all parts suitable for different selected media.

14. The apparatus of claim 13, wherein the superset ad includes at least one of:
a .wav file;
a .wmv file;
formatting for a browser;
formatting for television; and
formatting for print.

15. The apparatus of claim 12, wherein each different component will have at least some of its attributes as different from other components.

16. An apparatus for displaying a universal ad, the apparatus comprising:
a reader configured to read the universal ad replete with tags for different forms of media;
a tag identifier configured to identify different tags attached to the universal ad, the tags being associated with components of the universal ad;
a tag matcher configured to match each component with their respective media forms;
a tag translator configured to attach property values to each component; and
an ad display configured to display the universal ad correctly on a given media form.

17. The apparatus of claim 16, wherein the reader is a universal ad reader capable of reading, understanding and translating a wide range of formatted content.

18. The apparatus of claim 16, wherein the tag translator is further configured to create a subset of the universal ad.

19. The apparatus of claim 18, wherein the subset of the universal ad has property values that are tailored for a currently selected reader.

20. (canceled)

21. A computer readable medium carrying one or more instructions for creating a universal ad, wherein the one or more instructions, when executed by one or more processors, cause the one or more processors to perform the steps of:
generating a superset ad;
identifying different parts of the superset ad as separate components;
matching the separate components to their respective media;
attaching tags to each separate component; and
converting the superset ad to a universal ad.
